(19) United States
(12) Patent Application Publication
(10) Pub. No.: US 2012/0140940 A1
(43) Pub. Date: Jun. 7, 2012

(54) METHOD AND DEVICE FOR CANCELLING ACOUSTIC ECHO

(75) Inventors: In Ki HWANG, Daejeon-si (KR); Chang Y. CHOO, San Jose, CA (US); Do Young KIM, Daejeon (KR); Byung Sun LEE, Daejeon (KR)

(73) Assignee: Electronics and Telecommunications Research Institute, Daejeon (KR)

(21) Appl. No.: 13/216,698

(22) Filed: Aug. 24, 2011

Related U.S. Application Data
(60) Provisional application No. 61/420,410, filed on Dec. 7, 2010.

(30) Foreign Application Priority Data
Jun. 30, 2011 (KR) 10-2011-0064864

(51) Int. Cl. G10K 11/16

(52) U.S. Cl. 381/71.1

(57) ABSTRACT

An acoustic control device for generating a pseudo echo signal by filtering an input remote speaker signal by using a plurality of adaptive filters and controlling the adaptive filters to perform filtering based on filter coefficients generates an error signal by subtracting a pseudo echo signal from an input nearby speaker signal, determines a convergence state of the filter coefficient based on the error signal, and controls the width of data input to the adaptive filter when the filter coefficient is determined to be converged

### CROSS-REFERENCE TO RELATED APPLICATION

This application claims priority to and the benefit of U.S. patent Application No. 61/420,410 filed in the United States Patent and Trademark Office on Dec. 7, 2010 and Korean Patent Application No. 10-2011-0064864 filed in the Korean Intellectual Property Office on Jun. 30, 2011, the entire contents of which are incorporated herein by reference.

### BACKGROUND OF THE INVENTION

(a) Field of the Invention

The present invention relates to a device and method for cancelling an acoustic echo. More particularly, the present invention relates to a device and method for cancelling an echo that occurs when an acoustic signal is transmitted.

(b) Description of the Related Art

An acoustic echo signifies that a voice signal output by a speaker of a terminal is input to a microphone through various paths and is then transmitted to an original speaker that is a person spoke the voice signal, and the acoustic echo causes confusion during a call so methods for cancelling it have been used.

Methods for cancelling the acoustic echo use the time domain or the frequency domain, and they have been improved to satisfy the standards for reducing the echo to be less than a predetermined level, such as convergence time, long echo path performance, concurrent calling sensing time, or calculation. From among the methods, the acoustic echo cancelling method using the partitioned block frequency domain (PBFD) least mean square (LMS) method has a relatively faster convergence time and has strong performance on the long echo path compared to other algorithms. However, the method divides signals of a long path into partitioned blocks and processes the same, so it increases calculation and the terminal has difficulty in processing them in real time.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an acoustic echo cancelling device having fast performance with low power and a method thereof.

An exemplary embodiment of the present invention provides a method for cancelling an acoustic echo including: acquiring an error signal by subtracting a pseudo echo signal generated from a remote speaker signal from a nearby speaker signal; determining whether to set a low power mode based on the error signal; and when the low power mode is set, controlling data width used for an adaptive filter algorithm for cancelling the acoustic echo.

The controlling of a data width includes: reducing the data width by a first number when the value of the current error signal is less than the first threshold value; reducing the data width by a second number when the value of the current error signal is greater than the first threshold value and less than the second threshold value; and reducing the data width by a third number when the value of the current error signal is greater than the second threshold value and less than the third threshold value, and it is satisfied that the first number>the second number>the third number.

When the low power mode is set, a bypass mode for not performing at least one of a multiplication operation and an addition operation used for the adaptive filter algorithm is entered.

The entering a bypass mode includes entering the bypass mode when data input to the adaptive filter algorithm is “1” or “0.”

Another embodiment of the present invention provides a device for cancelling an acoustic echo including: a signal sampler for sampling a remote speaker signal generated and input by a remote device and outputting a plurality of sampling signals; an adaptive filter including a plurality of filter modules for processing the sampling signals according to filter coefficients corresponding to the sampling signals output by the signal sampler and outputting the processed sampling signals, and an addition module for adding the signals output by the filter modules and generating a pseudo echo signal; an error signal generator for generating an error signal by subtracting the pseudo echo signal from an input nearby speaker signal; and a filter controller for determining a convergence state of the filter coefficient based on the error signal, and controlling the width of data corresponding to a signal input to a filter module of the adaptive filter when the filter coefficient is found to be converged.

### BRIEF DESCRIPTION OF THE DRAWINGS

FIG. 1 shows a configuration diagram of an acoustic cancelling device according to an exemplary embodiment of the present invention.

FIG. 2 shows a process for an acoustic echo cancelling device according to an exemplary embodiment of the present invention to generate an error signal.

FIG. 3 shows a configuration of an FFT operator according to an exemplary embodiment of the present invention.

FIG. 4 shows a flowchart of an acoustic echo cancelling method according to an exemplary embodiment of the present invention.

FIG. 5 shows an operational flowchart in a bypass mode according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

An acoustic echo cancelling device and method thereof according to an exemplary embodiment of the present invention will now be described with reference to accompanying drawings.

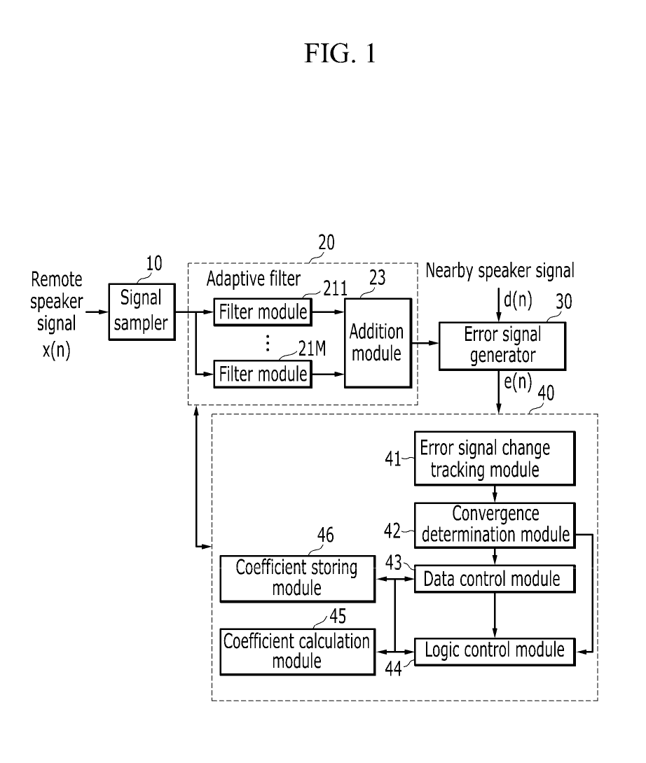

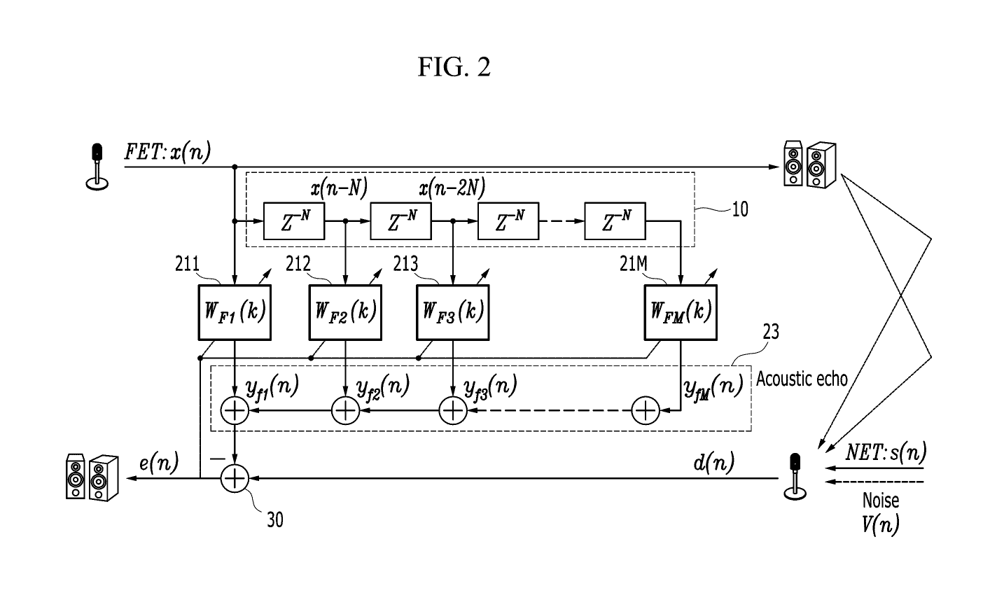

FIG. 1 shows a configuration diagram of an acoustic cancelling device according to an exemplary embodiment of the present invention, and FIG. 2 shows a process for an acoustic echo cancelling device according to an exemplary embodiment of the present invention to generate an error signal.

As shown in FIG. 1, the acoustic echo cancel device 1 includes a signal sampler 10, an adaptive filter 20, an error signal generator 30, and a filter controller 40.

The signal sampler 10 samples a signal (hereinafter, a remote speaker signal) generated and input by a remote device and outputs a sampled signal. For example, the signal sampler 10 samples the remote speaker signal (x(n)) to output N sampling signals as shown in FIG. 2.

The adaptive filter 20 generates a pseudo echo signal by processing the sampled remote speaker signal output by the signal sampler 10. In detail, the adaptive filter 20 includes M filter modules (211, 212, . . . , 21M) for processing and outputting sampling signals according to a filter coefficient in correspondence to N sampling signals, and an addition module 23 for summing the signals output by the M filter modules and generating a pseudo echo signal (y_{fM}(n)). The adaptive filter 20 generates an acoustic echo that is a pseudo echo signal for the entire N×M signals.

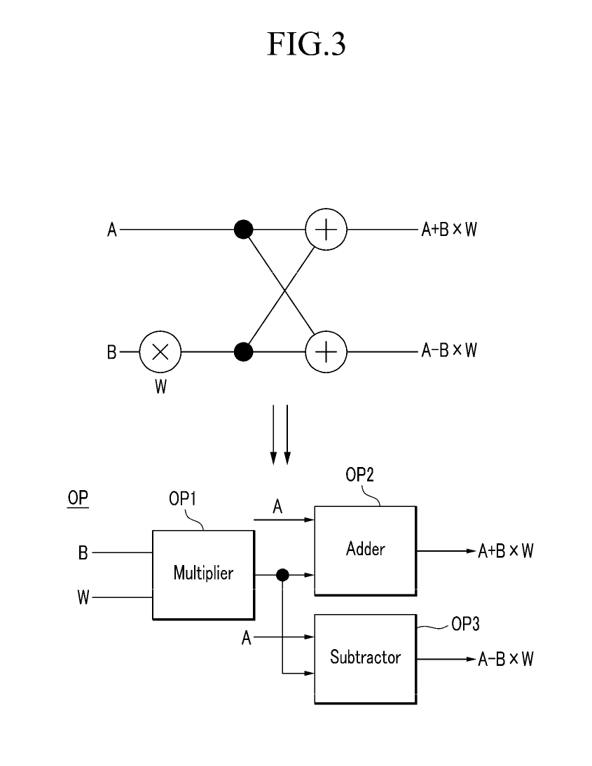

The filter modules (211, 212, . . . , 21M) include an FFT operator for processing the signals sampled according to the adaptive filter algorithm. FIG. 3 shows a configuration of an FFT operator according to an exemplary embodiment of the present invention. The FFT shown in FIG. 3 exemplifies a radix-2 FFT in a butterfly structure. In general, such radix-2 FFT operator performs complex number multiplication including real number multiplication 4 times and real number addition twice.

The FFT operator (OP) in the butterfly structure according to an exemplary embodiment of the present invention includes a multiplier OP1, an adder OP2, and a subtractor OP3, as shown in FIG. 3.

The multiplier OP1 multiplies the input signal B and the filter coefficient W and outputs a predetermined signal, and the adder OP2 adds the input signal A and the output signal provided by the multiplier OP1. The subtractor OP3 subtracts the input signal provided by the multiplier OP1 from the input signal A, and outputs a predetermined signal. Therefore, the signal output by the adder OP2 is A+B×W, and the signal output by the subtractor OP3 is A−B×W. Here, the filter coefficient W is a twiddle factor, and the operation of the FFT operator (OP) with such configuration is known to a person skilled in the art and no detailed description thereof will be provided.

In the exemplary embodiment of the present invention, when it is operated in the low power mode according to the convergence state of the filter coefficient, the data width input to the FFT operator (OP) in the butterfly structure is controlled to reduce the amount of the processed data, which will be described later.

The error signal generator 30 generates an echo signal, that is, an error signal, by subtracting a pseudo echo signal from a nearby speaker signal (d(n)) as shown in FIG. 2.

The filter controller 40 updates a filter coefficient of the adaptive filter 20, and particularly, the filter controller 40 determines whether to update the filter coefficient based on a current error signal generated and input by the error signal generator 30 and a previous error signal. For this purpose, the filter controller 40 includes an error signal change tracking module 41 for determining development of changes of the error signal based on the current error signal and the previous error signals, a convergence determination module 42 for determining a convergence state of the adaptive filter coefficient based on the development of changes of the error signal, a data control module 43 for controlling data that are input to the adaptive filter 20 according to the convergence state determination result, and a logic control module 44 for controlling driving of a logic operation of the adaptive filter 20. In addition, the adaptive filter 20 may further include a coefficient calculation module 45 for calculating the adaptive filter coefficient and a coefficient storing module 46 for storing the calculated filter coefficient. In this case, the coefficient storing module 46 may newly store the values calculated by the coefficient calculation module 45 for the respective filter coefficients or may store randomly established values (e.g., previously calculated values).

The data control module 43 controls the data that are input to the adaptive filter 20 according to the convergence state determination result, and in detail, when the filter coefficient is determined to be converged, it controls the data width of the sampled signals that are input to the adaptive filter 20.

When the value of the filter coefficient used for the adaptive filter 20 is already converged, the change of the value will not be great and reduction of the width of the input data will not generate a great influence. Therefore, when the low power mode is set according to the convergence of the filter coefficient, the input/output widths of the entire data are realized to be relative values with respect to the maximum value (e.g., 32 bit/16 bit). Also, the logic for processing high-order bits of the data is not driven to prevent the high-order bits from being processed. The operation mode for not driving a predetermined logic operation will be called a bypass mode.

It is needed to normalize audio data that are converted into digital signals so as to process the audio signals, which means limiting the data range to be between −1 and +1. For example, when 0.5 is expressed with 16 bits, it will be expressed as “0100_{—}0000_{—}0000_{—}0000”, meaning that 2¹⁴/2¹⁵=0.5. The most significant bit (MSB) of the 16 bits indicates a sign such as + or −, and other bits express the data values.

In this instance, the maximum value of +1 cannot be expressed. Accordingly, the multiplier using the input data having the actual value of +1 will improve the operation time and increase the accuracy of the result when it uses a bypass circuit to output other input data of the multiplier compared to the case of using the actual value of “0x7FFF”. For example, when 1×0.5 is to be realized, the actualized method becomes 0x7FFF×0x4000=0×1FFFC000. The MSB 2 bits are sign bits so the actual value becomes 0x3FFF, and the next bit value is “1” so it is rounded to 0x4000. In this case, the desired value of 0.5 is found, but it increases the processing time and power consumption since it is processed by using the multiplier and the rounding module.

Therefore, when the bypass mode is used while the input data is “1,” the speed is improved by the sum of the four cycles during which the multiplier is operable and the one cycle during which the rounding module is operable (hereinafter, a bypass cycle), and the operation is reduced by the amount processed during the bypass cycle. Also, when the input data is “0x0000,” no logic operation of the multiplier, the adder, or the subtractor is to be performed. This case also improves the processing speed and reduces the operation volume by using the bypass mode. Hence, in the case of the low power mode, the logic control module 44 performs the bypass mode according to the value of the input data while the data control module 43 controls the data width. In the bypass mode, at least one operation of the multiplier OP1, the adder OP2, and the subtractor OP3 of the FFT operator (OP) is disabled. For example, when the value of the input data is “1” or “0,” the bypass mode is performed.

The acoustic echo cancel device 1 cancels the acoustic echo by using the partitioned block frequency domain (PBFD) least mean square (LMS) method (hereinafter, PBFD-LMS method). The PBFD-LMS method outperforms the existing time domain least mean square (TD-LMS) method regarding the signal about a long echo path because, for example, it uses ⅙ the time to reach the +30 dB error return loss enhancement (ERLE) and it tracks the acoustic echo for the (N×M) samples. The exemplary embodiment of the present invention controls the data that are input to the adaptive filter according to the convergence state of the filter coefficient in order to cancel the acoustic echo with faster processing rates and low power consumption while using the PBFD-LMS method.

The acoustic echo cancel device according to an exemplary embodiment of the present invention may be realized to be an embedded system, and is not restricted thereto.

An acoustic echo cancelling method according to an exemplary embodiment of the present invention will now be described based on the above-described device.

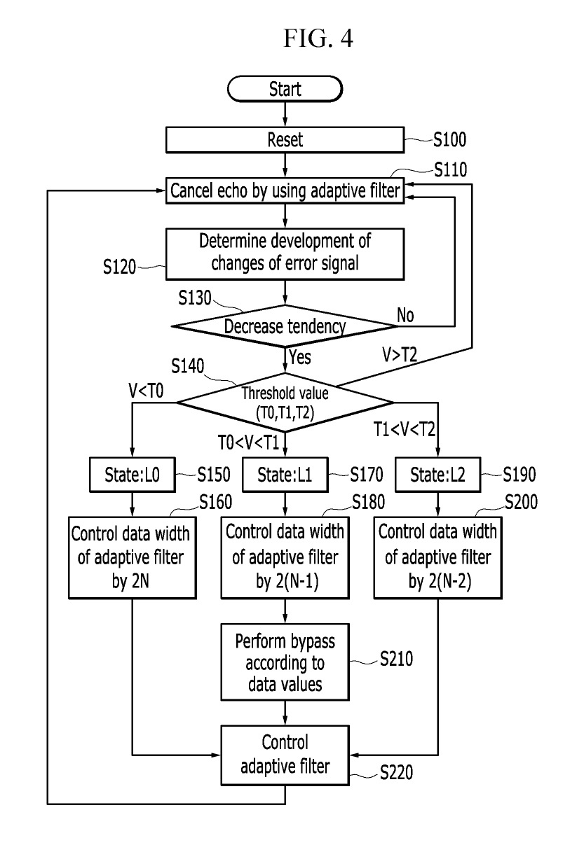

FIG. 4 shows a flowchart of an acoustic echo cancelling method according to an exemplary embodiment of the present invention.

A remote speaker signal x(n) generated by a remote device is input to an acoustic echo cancel device 1 to be sampled and is then processed by the adaptive filter 20, and the adaptive filter 20 processes the sampled remote speaker signal based on a predetermined adaptive filter coefficient (hereinafter, a filter coefficient) to generate a pseudo echo signal. A method for processing the sampled remote speaker signal based on the filter coefficient using an adaptive algorithm, particularly the PBFD-LMS algorithm, is known to a skilled person so a detailed description thereof will be omitted.

The pseudo echo signal generated by the adaptive filter 20 is input to the error signal generator 30, and the error signal generator 30 subtracts the pseudo echo signal from the input nearby speaker signal to output an error signal (S100 and S110).

The error signal change tracking module 41 of the filter controller 40 determines development of changes of the error signal based on a plurality of previously acquired error signals and a currently input error signal (hereinafter, a current error signal) that is processed and currently input by the error signal generator 30 (S120). That is, it determines the development of changes based on the L previous error signals and the current error signal being input. When the value of the previous error signal is subtracted from the value of the current error signal, the instant change of the error signal is known, so it calculates difference values for the L previous error signals and calculates a tendency value for expressing development of changes for the error signal based on the difference values. It determines the development of changes of the error signal based on the calculated tendency value, and particularly it determines the development of changes of the error signal by checking the change between the tendency values.

The current error signal is set to be E(L), and the L previous signals are set to be E(L−1), E(L−2), . . . , E(L−(L−1)), E(L−L). The difference values can be expressed to be an absolute value of the difference value between one error signal and its previous error signal, that is, E′(L)=|E(L)|−|E(L−1)|, E′(L−1)=|E(L−1)|−|E(L−2)|. Regarding the calculated difference values, the difference between one difference value and its previous difference value is found and is used as a tendency value. That is, the tendency value is defined to be E″(L)=E′(L)−E′(L−1). Based on it, a plurality of tendency values (E″(L)=E′(L)−E′(L−1), E″(L−1)=E′(L−1)−E′(L−2), . . . , E″(L−L)=E′(L−L)−E′(L−(L−1)) for a plurality of difference values are acquired.

The decrease or increase tendency for the error signal is determined by comparing the acquired tendency values and the previous tendency values (S130).

One tendency value E″(L) and its previous tendency value E″(L−1) are compared, and when the E″(L) is found to be equal to E″(L−1), the current error signal value is determined to be reduced. Particularly, the error value of the error signal is determined to be reduced with the same tendency.

On the other hand, when one tendency value is less than its previous tendency value, that is, E″(L)<E″(L−1), it is determined that the error signal value has the decrease tendency and the decrease tendency is becoming low. In the exemplary embodiment of the present invention, the error signal value has the decrease tendency, and when the decrease tendency is determined to be low, the current error signal value is compared with predetermined threshold values to determine a convergence state of the filter coefficient.

Further, when it is given that E″(L)>E″(L−1), the error signal value is determined to have the increase tendency, and the development of changes of the error signal values are tracked as described above until the error signal decrease tendency according to an exemplary embodiment of the present invention becomes low.

When the error signal decrease tendency is determined to be low, that is, when the current tendency value is compared and found to be less than or equal to the previous tendency value, an error value of the current error signal is compared with predetermined threshold values, and in the exemplary embodiment of the present invention, three threshold values T0, T1, and T2 are compared with the error value (S140). For ease of convenience, T0 will be called a first threshold value, T1 a second threshold value, and T2 a third threshold value, and the threshold values satisfy the relationship of T0<T1<T2.

In the exemplary embodiment of the present invention, when the error value of the current signal is less than the threshold values, the filter coefficient value is already converged, and in the convergence state, the acoustic echo cancel device 1 is operable in a low power mode in which the data are controlled and some logic operations are not driven, which will be described later. When the value of the adaptive filter coefficient is already converged, the value is not substantially changed. Therefore, the width of the data is controlled based on the convergence state, and the bypass mode is selectively performed. Particularly, in the exemplary embodiment of the present invention, the state in which the filter coefficient value is converged is classified into first to third states depending on the relationship between the error value and the threshold values, and the widths of the data controlled for the respective convergence states are different.

The data control module 43 of the filter controller 40 reduces the width of the data processed by the adaptive filter 20 by 2N (here, N is a positive integer) bits (S160) in the case of the first state (L0) (S150) in which the error value of the current error signal is less than the first threshold value T0 while the filter coefficient is converged. For example, when the data are set to have 16 bits, the data width is reduced to be 16 bits−2N bits.

In addition, when the error value of the current error signal is greater than the first threshold value T0 and is less than the second threshold value T1 (i.e., a second state L1) (S170), the data control module 43 reduces the width of the data processed by the adaptive filter 20 by 2(N−1) bits (S180). For example, when the data are set to have 16 bits, the data width is reduced to be 16 bits−2(N−1) bits.

When the error value of the current error signal is greater than the second threshold value T1 and is less than the third threshold value T2 (i.e., a third state L2) (S190), the data control module 43 reduces the width of the data processed by the adaptive filter 20 by 2(N−2) bits (S200). For example, when the data are set to have 16 bits, the data width is reduced to be 16 bits−2(N−2) bits.

When the error value of the current error signal is less than the first threshold value (i.e., the first state L0), the change of the value of the filter coefficient is determined to be not great, and the data width is further reduced compared to the other states L1 and L2. The data width reduced in the third state L2 is less than the data width reduced in the second state L1.

When the data width processed by the adaptive filter 20 is reduced through the above-described process, the data processing speed is improved and power used in processing the result is also reduced.

As described above, when the data width is controlled, the logic control module 44 selectively performs the bypass mode according to the value of the data input to the adaptive filter 20 (S210).

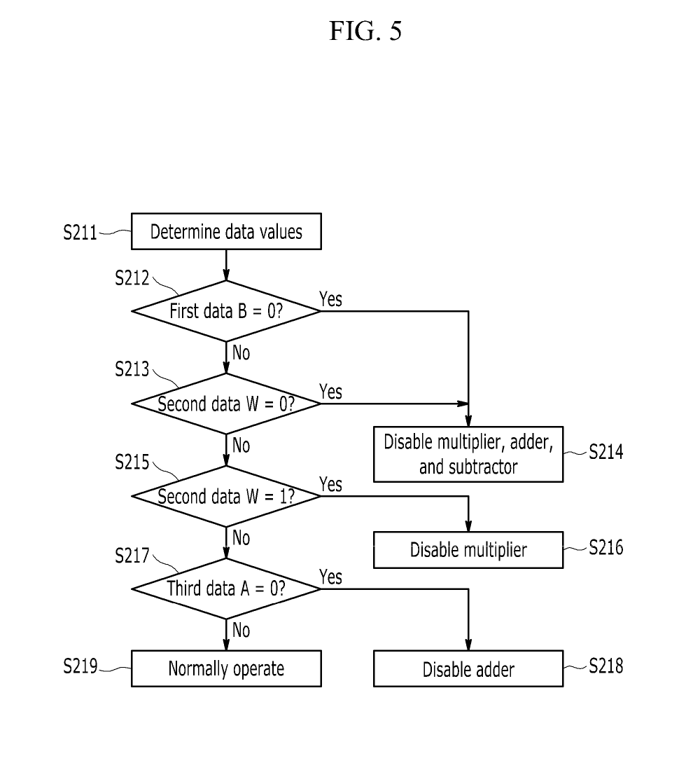

FIG. 5 shows an operational flowchart in the case of the bypass mode according to an exemplary embodiment of the present invention.

The value of the data input to the FFT operator (OP) of the adaptive filter 20 is determined to be “1” or “0,” and the bypass mode is performed when it is “1” or “0.”

As shown in FIG. 5, the logic control module 44 of the filter controller 40 determines whether the data B or W input to the multiplier OP1 of the FFT operator (OP) is “0” (S211-S213), and disables the multiplier OP1, the adder OP2, and the subtractor OP3 when it is “0” (S214). When one of the data input to the multiplier OP1 is “0,” the output of the multiplier OP1 is “0” so the value output by the adder OP2 for adding “0” and the input data or the subtractor OP3 for subtracting “0” and the input data is the data value input to the adder OP2 or the subtractor OP3. Therefore, since this case does not need an additional addition or subtraction process performed, the multiplier OP1, the adder OP2, and the subtractor OP3 are disabled.

Further, when the data B or W input to the multiplier OP1 is not “0,” the logic control module 44 determines whether the data W input to the multiplier OP1 is “1” (S215). When the data W input to the multiplier OP1 is “1,” the logic control module 44 disables the multiplier OP1. When one of the data input to the multiplier OP1 is “1,” other input data are output as they are to thereby disable the multiplier OP1 (S216). Here, it is determined whether the data W input to the multiplier OP1 is “1,” and without being restricted to this, the multiplier OP1 can be disabled when the data B is “1.”

That is, when one of the data input to the multiplier OP1 is “1,” the multiplier OP1 is disabled to stop performance of another multiplication operation.

When the data B or W input to the multiplier OP1 is not “0” or “1,” the logic control module 44 determines whether the data A input to the adder OP2 or the subtractor OP3 is “0” (S217). When the data A is “0,” the adder OP2 is disabled (S218). When one of the data input to the adder OP2 is “0,” other input data are output as they are to thus disable the adder OP2. The subtractor OP3 changes the sign of the output value when the input data is “0,” and the subtractor OP3 performs the subtraction operation.

Some logic for performing the operation according to the data value is not performed through the bypass mode, thereby improving the processing speed by the speed used for performing the corresponding logic operation and reducing power consumption used for processing the result.

Also, when the data values are not “0” or “1,” the multiplier OP1, the adder OP2, and the subtractor OP3 are normally operated to perform the corresponding operation (S210).

In the low power mode in which the development of changes of the error value has the decrease tendency, the filter coefficient is determined to be converged based on the error value of the current error signal and the operation for the filter coefficients is bypassed, and when the development of changes of the value of the error signal is observed as described above to determine that the error signal value has the increase tendency (e.g., when the current tendency value is greater than the previous tendency value), or when the value of the current error signal is greater than the threshold values during the decrease tendency, the low power mode is restored to the normal operational mode to restore the data width to the original state, enter no bypass mode, and control the FFT operator (OP) of the adaptive filter 20 to perform the corresponding operations.

According to the exemplary embodiment of the present invention, when the adaptive filter algorithm is used to cancel the acoustic echo, the data process is omitted to improve the speed for cancelling the echo signal by controlling the data width or bypassing the operation of a predetermined logic used for the adaptive filter algorithm according to the data value, and as a result, power used for the process is also reduced.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for cancelling an acoustic echo, comprising:
acquiring an error signal by subtracting a pseudo echo signal generated from a remote speaker signal from a nearby speaker signal;
determining whether to set a low power mode based on the error signal; and
when the low power mode is set, controlling data width used for an adaptive filter algorithm for cancelling the acoustic echo.

2. The method of claim 1, wherein
the controlling of a data width includes reducing the data width when the low power mode is set.

3. The method of claim 1, wherein
the determining of whether to set includes determining whether to set the low power mode based on a value of a current error signal and development of changes of error values based on error signal values.

4. The method of claim 3, wherein
the determining of whether to set includes:
acquiring tendency values for indicating development of changes of the error value based on a difference value between the value of the currently acquired error signal and the value of at least previously acquired one error signal;
comparing the tendency values and determining an error value increase tendency or an error value decrease tendency;
when the error value is found to have the decrease tendency, comparing the value of the current error signal with at least one threshold value; and
when the value of the current error signal is less than the threshold value, determining to set the low power mode.

5. The method of claim 4, wherein
the acquiring of a tendency value uses a difference between one difference value and a previous difference value for the tendency value.

6. The method of claim 5, wherein
when the current error signal is E(L) and L previous error signals (E(L−1), E(L−2), . . . , E(0)) are used, the one difference value E′(L) and the previous difference value E′(L−1) satisfy the subsequent conditions, and the tendency value E″(L) satisfies the next condition:
E′(L)=|E(L)|−|E(L−1)|,
E′(L−1)=|E(L−1)|−|E(L−2)|, and
E″(L)=E′(L)−E′(L−1)

7. The method of claim 6, wherein
the determining of a tendency includes
comparing one tendency value E″(L) and its previous tendency value E″(L−1)=E′(L−1)−E′(L−2), and when E″(L) is found to be less than or equal to E″(L−1), determining that the error value has the decrease tendency.

8. The method of claim 4, wherein
the comparing with a threshold value includes comparing a value of a current error signal with first to third threshold values, and
determining to set the low power mode includes setting the low power mode when the value of the current error signal is less than the first to third threshold values.

9. The method of claim 8, wherein
the first threshold value<the second threshold value<the third threshold value is satisfied.

10. The method of claim 9, wherein
the controlling of a data width includes:
reducing the data width by a first number when the value of the current error signal is less than the first threshold value;
reducing the data width by a second number when the value of the current error signal is greater than the first threshold value and less than the second threshold value; and
reducing the data width by a third number when the value of the current error signal is greater than the second threshold value and less than the third threshold value, and
the first number>the second number>the third number is satisfied.

11. The method of claim 1, further including,
when the low power mode is set, entering a bypass mode for not performing at least one of a multiplication operation and an addition operation used for the adaptive filter algorithm.

12. The method of claim 11, wherein
the entering a bypass mode includes entering the bypass mode when data input to the adaptive filter algorithm is “1” or “0.”

13. The method of claim 12, wherein
the adaptive filter algorithm performs a multiplication operation for multiplying first data and second data, an addition operation for adding third data and output data of the multiplication operation, and a subtraction operation for subtracting output data of the multiplication operation from the third data, and
when in the bypass mode:
no multiplication operation, no addition operation, and no subtraction operation are performed when first data or second data for the multiplication operation is “0”;
no multiplication operation is performed when first data or second data for the multiplication operation is “1”; and
no addition operation is performed when the first data or the second data is not “0” or “1” and the third data is “0.”

14. The method of claim 1, wherein
the determining of setting a low power mode based on the error signal includes determining that a filter coefficient used for the adaptive filter algorithm is converged, and setting the low power mode when the error value is determined have the decrease tendency based on a difference value between a value of the currently acquired error signal and a value of at least one error signal and the value of the current error signal is less than a predetermined threshold value.

15. A device for cancelling an acoustic echo, comprising:
a signal sampler for sampling a remote speaker signal generated and input by a remote device and outputting a plurality of sampling signals;
an adaptive filter including a plurality of filter modules for processing the sampling signals according to filter coefficients corresponding to the sampling signals output by the signal sampler and outputting the processed sampling signals, and an addition module for adding the signals output by the filter modules and generating a pseudo echo signal;
an error signal generator for generating an error signal by subtracting the pseudo echo signal from an input nearby speaker signal; and
a filter controller for determining a convergence state of the filter coefficient based on the error signal, and controlling the width of data corresponding to a signal input to a filter module of the adaptive filter when the filter coefficient is found to be converged.

16. The device of claim 15, wherein
the filter controller includes:
an error signal change tracking module for determining development of changes of an error signal based on a current error signal and previous error signals;
a convergence determination module for determining the convergence state of the adaptive filter coefficient by comparing the value of the current error signal and the predetermined threshold value when the error signal has the decrease tendency according to the result of determining the development of changes; and
a data control module for reducing the width of data input to the adaptive filter when the filter coefficient is converged.

17. The device of claim 16, wherein
the data control module
reduces the data width by a first number when the value of the current error signal is less than the first threshold value,
reduces the data width by a second number when the value of the current error signal is greater than the first threshold value and less than the second threshold value,
and reduces the data width by a third number when the value of the current error signal is greater than the second threshold value and less than the third threshold value, and
the first number>the second number>the third number is satisfied.

18. The device of claim 16, wherein
the filter module includes:
a multiplier for multiplying input first data and second data;
an adder for adding input third data and output data of the multiplication operation; and
a subtractor for subtracting output data of the multiplication operation from the third data, and
the filter controller further includes
a logic control module for entering a bypass mode for not operating at least one of the multiplier, the adder, and the subtractor of the filter module when the filter coefficient is converged.

19. The device of claim 18, wherein
the logic control module performs the bypass mode when the first data, the second data, and the third data are “1” or “0.”

20. The device of claim 19, wherein
the logic control module disables the multiplier, the adder, and the subtractor when the first data or the second data is “0,” disables the multiplier when the first data or the second data is “1,” and disables the adder when the third data is “0” while the first data or the second data is not “0” or “1.”
